(19) United States
(12) Patent Application Publication
(10) Pub. No.: US 2025/0304878 A1
(43) Pub. Date: Oct. 2, 2025

(54) PRE-CURED SINGLE-COMPONENT THERMAL CONDUCTIVE GEL AND PREPARATION METHOD THEREFOR

(71) Applicants: GUANGZHOU BAIYUN TECHNOLOGY CO., LTD., Guangdong (CN); GUANGDONG BAIYUN TECHNOLOGY CO., LTD., Guangdong (CN)

(72) Inventors: Guanghua LIU, Guangdong (CN); Jianjun CHEN, Guangdong (CN); Yuwen LUO, Guangdong (CN); Lubin YE, Guangdong (CN); Hengchao HUANG, Guangdong (CN); Mingsong MIAO, Guangdong (CN)

(73) Assignees: GUANGZHOU BAIYUN TECHNOLOGY CO., LTD., Guangdong (CN); GUANGDONG BAIYUN TECHNOLOGY CO., LTD., Guangdong (CN)

(21) Appl. No.: 19/236,930

(22) Filed: Jun. 12, 2025

Related U.S. Application Data
(63) Continuation of application No. PCT/CN2022/140892, filed on Dec. 22, 2022.

(51) Int. Cl. C10M 169/04; B01J 27/13; C08G 77/44

(52) U.S. Cl. CPC C10M 169/04; B01J 27/13; C08G 77/44; C10M 2201/062; C10M 2229/025; C10M 2290/04

(57) ABSTRACT

Disclosed are a pre-cured single-component thermal gel and a preparation method therefor. The pre-cured single-component thermal gel is prepared from the following components in parts by weight and a platinum catalyst: 100 parts of vinyl-terminated silicone oil, 5-30 parts of branched hydrogen-containing silicone oil, 500-2500 parts of modified thermally conductive powder, and 0.01-0.3 part of an inhibitor; the content of the platinum catalyst is 2 ppm to 10 ppm on the basis of the mass of platinum; the modified thermally conductive powder is prepared by modifying thermally conductive powder with a modifier; and the modifier consists of long-chain alkyl silane and vinyl silane.

### CROSS-REFERENCE TO RELATED APPLICATION

This application is a continuation application of the international PCT application serial no. PCT/CN2022/140892, filed on Dec. 22, 2022. The entirety of the above-mentioned patent application is hereby incorporated by reference herein and made a part of this specification.

### TECHNICAL FIELD

The present disclosure relates to the field of thermal conductive gel, particularly to a pre-cured single-component thermal conductive gel and preparation method therefor.

### RELATED ART

With the booming development of 5G communication technology and new energy vehicles, both consumer electronics terminal devices and automotive “three electric” systems have put forward higher requirements for heat dissipation. In this context, silicone thermal conductive gel, as a new thermal interface material, has attracted much attention in the industry due to its advantages of both thermal conductive gasket and thermal conductive silicone grease. According to the current application forms, the silicone thermal conductive gel is mainly divided into single-component thermal conductive gel and two-component thermal conductive gel. The single-component thermal conductive gel is a single-component packaging form, which is a pre-cured product, and does not need further vulcanization after dispensing. Compared with the two-component thermal conductive gel, the application and construction are more convenient.

In addition to thermal conductivity, single-component thermal conductive gel has two additional key indicators, one is the extrusion rate and the other is oil seepage. The single-component thermal conductive gel is a pre-cured form. Due to the need to ensure a certain extrusion rate, the cross-linking density is designed to be very low, which will inevitably lead to the risk of oil seepage, i.e., the separation of polymer and powder.

CN115403933A discloses a high extrusion, low oil bleeding rate, single-component thermal conductive gel and the preparation method thereof, which increases the porosity of boron nitride by surface treatment, to improve the adsorption capacity of boron nitride on silicone oil molecules, and reduces the possibility of oil seepage due to the separation of silicone oil molecules from the system. However, the special structure and high oil absorption value of boron nitride will also significantly reduce the extrusion rate of thermal conductive gel, making it difficult to take both into account at the same time.

### SUMMARY OF INVENTION

The purpose of the present disclosure is to provide a single-component thermal conductive gel with good thermal conductivity, high extrusion rate and low oil bleeding rate.

In order to achieve the above purpose, the present disclosure includes the following technical solutions.

A pre-cured single-component thermal conductive gel is prepared from the following components in parts by weight and a platinum catalyst:

| | | |
|---|---|---|
| vinyl-terminated silicone oil | 100 | parts |
| branched hydrogen-containing silicone oil | 5 to 30 | parts |
| modified thermal conductive powder | 500 to 2500 | parts |
| inhibitor | 0.01 to 0.3 | part |

wherein, the content of the platinum catalyst is 2 ppm to 10 ppm based on the mass of platinum;
wherein, the structure of the branched hydrogen-containing silicone oil is:

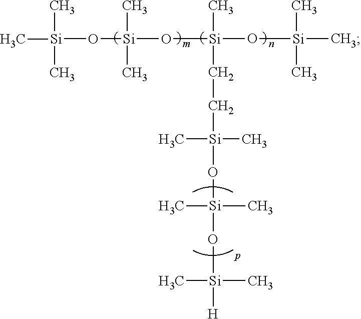

wherein, the modified thermal conductive powder is prepared by modifying thermal conductive powder with a modifier;
and wherein, the modifier is composed of long-chain alkyl silane and vinyl silane,
wherein, the branched hydrogen-containing silicone oil is prepared by a hydrosilylation reaction of a hydrogen-terminated silicone oil and a side-chain vinyl silicone oil under the action of a platinum catalyst, and the reaction equation is as follows:

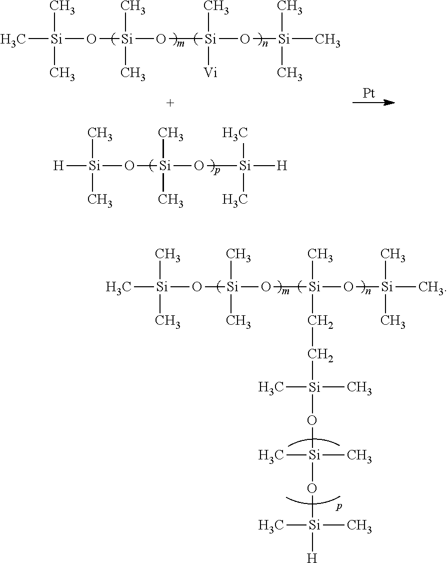

The present disclosure also provides a method for preparation of the pre-cured single-component thermal conductive gel, including the following technical solutions:

A method for preparing the above-mentioned pre-cured single-component thermal conductive gel includes the following steps:
(1) putting vinyl-terminated silicone oil, branched hydrogen-containing silicone oil, and inhibitor into a planetary mixer, stirring and mixing evenly, and then adding modified thermal conductive powder in batches, followed by stirring until the mixture is evenly mixed;
(2) putting a catalyst into the planetary mixer stirring and mixing evenly, and removing bubbles by vacuuming;
(3) heating and pre-curing the mixture obtained in step (2) to obtain a pre-cured single-component thermal conductive gel.

The present disclosure has the following beneficial effects:

The present disclosure produces a branched hydrogen-containing silicone oil through a hydrosilylation reaction using hydrogen-terminated silicone oil and side-chain vinyl silicone oil under the action of a platinum catalyst; in addition, a modified thermal conductive powder is prepared by modifying the thermal conductive powder with a modifier composed of long-chain alkyl silane and vinyl silane; then, the branched hydrogen-containing silicone oil and the modified thermal conductive powder are combined with vinyl-terminated silicone oil, a certain amount of inhibitor and platinum catalyst to prepare a pre-cured single-component thermal conductive gel with excellent thermal conductivity, high extrusion rate and low oil bleeding rate.

Wherein, branched hydrogen-containing silicone oil is used to replace conventional side hydrogen-containing silicone oil and hydrogen-terminated silicone oil as crosslinking agents, its branched structure can form a large silicone cross-linking network, which has an anchoring effect on the thermal conductive powder, increasing the bonding force between the polymer and the powder, without causing poor extrusion due to excessive cross-linking density; furthermore, a modifier composed of long-chain alkyl silane and vinyl silane is used to modify the thermal conductive powder. The surface of the modified thermal conductive powder contains not only long-chain alkyl groups, but also active reactive groups such as vinyl groups, which allows the modified powder to undergo a hydrosilylation reaction with branched hydrogen-containing silicone oil, resulting in not only physical interactions but also chemical bonding between the powder and polymer, further reducing polymer precipitation. Under the coordination of branched hydrogen-containing silicone oil and modified thermal conductivity powder, the pre-cured single-component thermal conductive gel prepared by the present disclosure has the advantages of excellent thermal conductivity, high extrusion rate and low oil bleeding rate compared with the existing single-component thermal conductive gel.

### DESCRIPTION OF EMBODIMENTS

The following will further illustrate the technical solutions of the present disclosure through specific embodiments. Technicians in this field should understand that the described embodiments are only intended to help understanding the present disclosure and should not be considered as specific limitations to the present disclosure.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure.

The terms “including” and “having” of the present disclosure, as well as any variations thereof, are intended to cover non-exclusive inclusions. For example, a process, method, device, product, or equipment that includes a series of steps is not limited to the listed steps or modules, but optionally includes steps that are not listed, or alternatively includes other steps inherent to these processes, methods, products, or devices.

The term “multiple” mentioned in the present disclosure refers to two or more. “And/or” describes the relationship of the associated objects, indicating that there can be three types of relationships. For example, A and/or B can represent: the existence of A alone, the coexistence of A and B, and the existence of B alone. The character “/” generally indicates that the associated objects are in an “or” relationship.

In one embodiment of the present disclosure, a pre-cured single-component thermal conductive gel being prepared from the following components in parts by weight and a platinum catalyst is provided:

| | | |
|---|---|---|
| vinyl-terminated silicone oil | 100 | parts |
| branched hydrogen-containing silicone oil | 5 to 30 | parts |
| modified thermal conductive powder | 500 to 2500 | parts |
| inhibitor | 0.01 to 0.3 | part |

wherein, the content of the platinum catalyst is 2 ppm to 10 ppm based on the mass of platinum;
the structure of the branched hydrogen-containing silicone oil is:

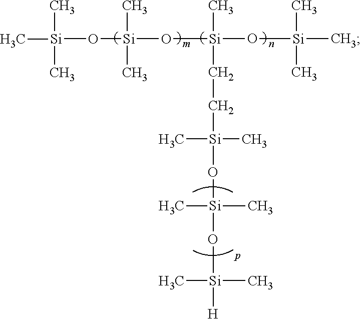

wherein, the modified thermal conductive powder is prepared by modifying thermal conductive powder with a modifier;
and wherein, the modifier consists of long-chain alkyl silane and vinyl silane.

The present disclosure produces a branched hydrogen-containing silicone oil through a hydrosilylation reaction using hydrogen-terminated silicone oil and side-chain vinyl silicone oil under the action of platinum catalyst; additionally, a modified thermal conductive powder is prepared by modifying the thermal conductive powder with a modifier composed of long-chain alkyl silane and vinyl silane; then, the branched hydrogen-containing silicone oil and the modified thermal conductive powder are combined with vinyl-terminated silicone oil, a certain amount of inhibitor and platinum catalyst to prepare a pre-cured single-component thermal conductive gel with excellent thermal conductivity, high extrusion rate and low oil bleeding rate.

Wherein, using branched hydrogen-containing silicone oil instead of conventional side hydrogen-containing silicone oil and hydrogen-terminated silicone oil as cross-linking agents, its branched structure can form a large silicone cross-linking network, which has an anchoring effect on the thermal conductive powder, increasing the bonding force between the polymer and the powder, while not causing poor extrusion due to excessive cross-linking density; furthermore, a modifier composed of long-chain alkyl silane and vinyl silane is used to modify the thermal conductive powder. The surface of the modified thermal conductive powder not only contains long-chain alkyl groups, but also contains active reactive groups such as vinyl groups, which allows the modified powder to undergo a hydrosilylation reaction with branched hydrogen-containing silicone oil, resulting in not only physical interactions but also chemical bonding between the powder and polymer, further reducing polymer precipitation. Under the coordination of branched hydrogen-containing silicone oil and modified thermal conductive powder, the pre-cured single-component thermal conductive gel prepared by the disclosure has the advantages of excellent thermal conductivity, high extrusion rate and low oil bleeding rate compared with the existing single-component thermal conductive gel.

The weight parts of the branched hydrogen-containing silicone oil in the present disclosure can be: 5 parts, 6 parts, 7 parts, 8 parts, 9 parts, 10 parts, 11 parts, 12 parts, 13 parts, 14 parts, 15 parts, 16 parts, 17 parts, 18 parts, 19 parts, 20 parts, 21 parts, 22 parts, 23 parts, 24 parts, 25 parts, 26 parts, 27 parts, 28 parts, 29 parts, 30 parts, etc.

The weight parts of the modified thermal conductive powder in the present disclosure can be: 500 parts, 600 parts, 700 parts, 800 parts, 900 parts, 1000 parts, 1100 parts, 1200 parts, 1300 parts, 1400 parts, 1500 parts, 1600 parts, 1700 parts, 1800 parts, 1900 parts, 2000 parts, 2100 parts, 2200 parts, 2300 parts, 2400 parts, 2500 parts, etc.

The weight parts of the inhibitor in the present disclosure can be 0.01 part, 0.02 part, 0.05 part, 0.08 part, 0.1 part, 0.15 part, 0.2 part, 0.25 part, 0.28 part, 0.3 part, etc.

In some preferred embodiments, pre-cured single-component thermal conductive gel, being prepared from the following components in parts by weight and a platinum catalyst:

| | | |
|---|---|---|
| vinyl-terminated silicone oil | 100 | parts |
| branched hydrogen-containing silicone oil | 10 to 20 | parts |
| modified thermal conductive powder | 1000 to 2000 | parts |
| inhibitor | 0.01 to 0.3 | part |

the content of the platinum catalyst is 2 ppm to 10 ppm based on the mass of platinum.

In some preferred embodiments, the branched hydrogen-containing silicone oil is prepared by a hydrosilylation reaction of a hydrogen-terminated silicone oil and a side-chain vinyl silicone oil under the action of a platinum catalyst, and the reaction equation is as follows:

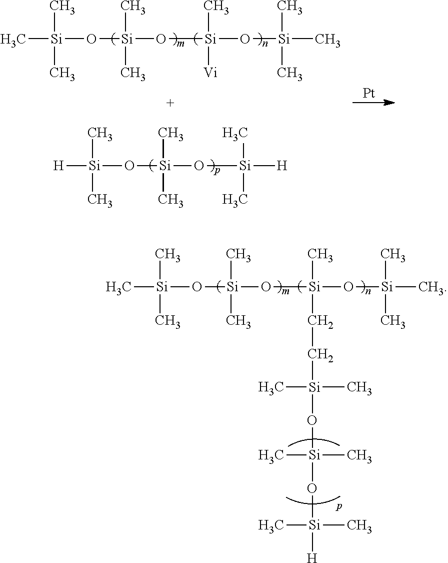

In some preferred embodiments, the mass ratio of hydrogen-containing silicone oil and side vinyl silicone oil is 1:4 to 6, more preferably 1:4.5 to 5.5, for example, it can be 1:5.

In some preferred embodiments, the viscosity of the side vinyl silicone oil is 100 mPa·s to 500 mPa·s, and the vinyl content is 0.3 wt % to 1.0 wt %; the hydrogen content of the hydrogen-terminated silicone oil is 0.05 wt % to 0.2 wt %.

Further preferably, the viscosity of the side vinyl silicone oil is 150 mPa·s to 250 mPa·s, and the vinyl content is 0.4 wt % to 0.6 wt %; the hydrogen content of the hydrogen-terminated silicone oil is 0.08 wt % to 0.12 wt %.

In some preferred embodiments, the viscosity of the branched hydrogen-containing silicone oil is 200 mPa·s to 1000 mPa·s, and the hydrogen content is 0.008 wt % to 0.15 wt %.

Further preferably, the viscosity of the branched hydrogen-containing silicone oil is 500 mPa·s to 600 mPa·s, and the hydrogen content is 0.01 wt % to 0.02 wt %.

In some preferred embodiments, the preparation method of the branched hydrogen-containing silicone oil comprises the following steps:
adding a side-chain vinyl silicone oil, a platinum catalyst, and a solvent into a reaction bottle, stirring evenly, and then dripping the hydrogen-terminated silicone oil, followed by heating up to 70° C. to 90° C. and reacting for 0.5 h to 2 h to obtain the product.

Wherein, the solvent can be an organic solvent commonly used in hydrosilylation reactions, such as toluene.

In some preferred embodiments, the long-chain alkylsilane is selected from at least one from C₈ to C₁₆ alkyltrimethoxysilane. For example, octanetrimethoxysilane, nonanetrimethoxysilane, Decyltrimethoxysilane, undecyltrimethoxysilane, dodecyltrimethoxysilane, tridecyltrimethoxysilane, tetradecyltrimethoxysilane, pentadecyltrimethoxysilane, and hexadecyltrimethoxysilane.

In some preferred embodiments, the vinylsilane is vinyltrimethoxysilane and/or vinyltriethoxysilane.

In some preferred embodiments, the modifier is composed of long-chain alkyl silane and vinyl silane in a mass ratio of 12 to 1:1.

Further preferably, the modifier is composed of long-chain alkyl silane and vinyl silane in a mass ratio of 9 to 3:1.

For example, the modifier is composed of dodecyltrimethoxysilane and vinyltriethoxysilane in a mass ratio of 9:1, or dodecyltrimethoxysilane and vinyltriethoxysilane in a mass ratio of 6:1, or dodecyltrimethoxysilane and vinyltriethoxysilane in a mass ratio of 3:1.

Excessive use of long-chain alkyl silane will lead to an increase in oil bleeding rate, while excessive use of vinyl silane will result in a decrease in extrusion rate; long-chain alkyl silane and vinyl silane are compounded with the modified thermal conductive powder in the preferred ratio in the present disclosure, which can make the obtained thermal conductive gel give consideration to excellent thermal conductivity and extrusion rate, and have low oil bleeding rate.

In some preferred embodiments, the thermal conductive powder is selected from one or a combination of aluminum oxide, zinc oxide, magnesium oxide, aluminum nitride, and boron nitride.

In some preferred embodiments, the mass ratio of the thermal conductive powder to the modifier is 100:0.2 to 1.5, preferably 100:0.3 to 1.2, and more preferably 100:0.3 to 1. For example, the mass ratio of thermal conductive powder to modifier is 100:0.3, or 100:0.5, or 100:1.

If the amount of modifier is too high, the thermal conductivity of the thermal conductive gel will be reduced to a certain extent. If the amount is too low, the effect of significantly reducing the oil bleeding rate and significantly improving the extrusion rate will not be achieved. The mass ratio of the thermal conductive powder and the modifier is within the preferred range of the disclosure, which can make the obtained thermal conductive gel give consideration to both excellent thermal conductivity and the extrusion rate, and the oil bleeding rate is low.

In some embodiments, the preparation method of the modified thermal conductive powder includes the following steps: adding the thermal conductive powder into a reaction vessel, atomizing the modifier while stirring, spraying it into the reaction vessel, heating to 60° C. to 80° C., and reacting for 2 h to 3 h to obtain the modified thermal conductive powder.

In some preferred embodiments, the viscosity of the end vinyl silicone oil is between 50 mPa·s to 2000 mPa·s, preferably between 100 mPa·s to 1000 mPa·s, and more preferably between 100 mPa·s to 200 mPa·s.

In some embodiments, the platinum catalyst is selected from one or a combination of chloroplatinic acid, chloroplatinic acid isopropanol complex, and Castell catalyst.

In some embodiments, the inhibitor is selected from one or a combination of 1-ethynyl-1-cyclohexanol, tetramethyltetravinylcyclotetrasiloxane, 2-methyl-3-butyn-2-ol, 3-methyl-1-hexyn-3-ol, 3,5-dimethyl-1-hexyn-3-ol, and 3-methyl-1-dodecyn-3-ol.

The thermal conductive gel of the disclosure can be prepared by the conventional preparation method in the art.

In some embodiments, a method for preparation of thermal conductive gel, comprising the following steps:
(1) putting the vinyl-terminated silicone oil, branched hydrogen-containing silicone oil, and inhibitor into a planetary mixer, stirring and mixing evenly, and then adding the modified thermal conductive powder in batches, followed by stirring until the mixture is evenly mixed;
(2) putting the catalyst into the planetary mixer, stirring and mixing evenly, and removing bubbles by vacuuming;
(3) heating and pre-curing the mixture obtained in step (2) to obtain the pre-cured single-component thermal conductive gel.

In some embodiments, a method for preparation of thermal conductive gel, comprising the following steps:
(1) putting the vinyl-terminated silicone oil, branched hydrogen-containing silicone oil, and inhibitor into a planetary mixer, stirring for 5 min to 10 min and mixing evenly, and then adding the modified thermal conductive powder in batches, followed by stirring 20 min to 30 min until the mixture is evenly mixed;
(2) putting the catalyst into the planetary mixer, stirring for 10 min to 20 min and mixing evenly, and removing bubbles by vacuuming;
(3) heating and pre-curing the mixture obtained in step (2) for 1 h to 3 h at 50° C. to 70° C. to obtain the pre-cured single-component thermal conductive gel.

The viscosity mentioned in the present disclosure refers to the viscosity at 25° C.

The “vinyl-terminated silicone oil” in the present disclosure refers to polydimethylsiloxane with Si-Vi groups at both ends of each molecule, wherein Vi refers to vinyl.

The “hydrogen-terminated silicone oil” in the present disclosure refers to polydimethylsiloxane with Si—H groups at both ends of each molecule.

In the following embodiments, the content of Castell catalyst is calculated based on the mass of platinum.

The reaction formula for preparing branched hydrogen-containing silicone oil in the present disclosure is as follows:

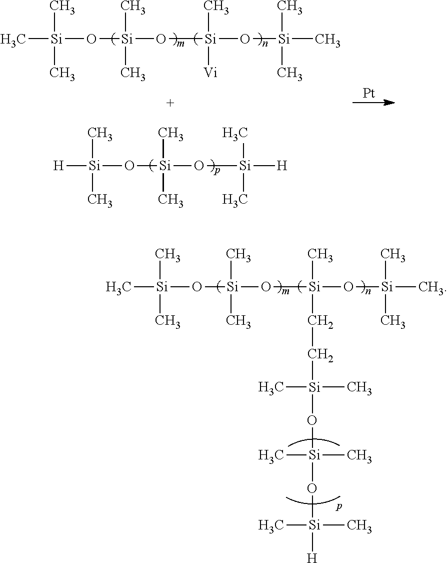

The preparation method includes the following steps:
a: adding 100 parts of side-chain vinyl silicone oil with viscosity of 200 mPa·s and ethylene content of 0.5 wt %, 5 ppm (based on Pt content) of Castell catalyst, and 200 parts of toluene to a three-necked flask equipped with a stirrer, reflux condenser, dropper funnel, and thermometer, and stirring evenly;
b: slowly dripping 20 parts of hydrogen-containing silicone oil with hydrogen content of 0.1 wt % into the above mixture, heating up to 80° C. and reacting under reflux for 1 hour;
c: after the reaction completed, evaporating toluene and removing the catalyst by adsorption with activated carbon to obtain branched hydrogen-containing silicone oil; after testing, its viscosity is 550 mPa·s and its hydrogen content is 0.015 wt %.

The preparation method of the modified thermal conductive powder of the present disclosure includes the following steps:

Adding 100 parts of thermal conductive powder into the stirring vessel, and while stirring, spraying 0.2 to 1.0 part of a modifier composed of long-chain alkyl silane and vinyl silane (with a mixing mass ratio of 9 to 3:1) after atomized into the stirring vessel; heating up to 70° C. and reacting for 2.5 hours to obtain the modified thermal conductive powder.

The following are specific implementation examples.

### Embodiment 1

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity iscosity was 100 mPa · s | 100 |
| silicone oil | | |
| Branched hydrogen- | The viscosity was 550 mPa · s (25° C.), | 15 |
| containing silicone | hydrogen content was 0.015 wt % | |
| oil | | |
| Modified thermally | Modified alumina, with a modifier composed of | 1500 |
| conductive powder | dodecyltrimethoxysilane and vinyltriethoxysilane | |
| | in a mass ratio of 6:1. The total amount of | |
| | modifier used was 0.3% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Embodiment 2

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s | 100 |
| silicone oil | | |
| Branched hydrogen- | The viscosity was 550 mPa · s (25° C.), | 15 |
| containing silicone | the hydrogen content was 0.015 wt % | |
| oil | | |
| Modified thermally | Modified alumina, with a modifier composed of | 1500 |
| conductive powder | dodecyltrimethoxysilane and vinyltriethoxysilane | |
| | in a mass ratio of 6:1. The total amount of | |
| | modifier used is 0.5% of the mass of | |
| | alumina powder | |
| Inhibitor | 1-ethynyl-1-cyclohexanol | 0.2 |
| Catalyst | Castell | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Embodiment 3

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s | 100 |
| silicone oil | | |
| Branched hydrogen- | The viscosity was 550 mPa · s (25° C.), | 15 |
| containing silicone | the hydrogen content was 0.015 wt % | |
| oil | | |
| Modified thermally | Modified alumina, with a modifier composed of | 1500 |
| conductive powder | dodecyltrimethoxysilane and vinyltriethoxysilane | |
| | in a mass ratio of 6:1. The total amount of | |
| | modifier used was 1.0% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Embodiment 4

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s | 100 |
| silicone oil | | |
| Branched hydrogen- | The viscosity was 550 mPa · s (25° C.), | 15 |
| containing silicone | the hydrogen content was 0.015 wt % | |
| oil | | |
| Modified thermally | Modified alumina, with a modifier composed of | 1500 |
| conductive powder | dodecyltrimethoxysilane and vinyltriethoxysilane | |
| | in a mass ratio of 9:1. The total amount of | |
| | modifier used was 0.5% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Embodiment 5

This embodiment provided a pre-cured single component thermal gel, with raw material composition as follows:

| | Name or related parameters | Dosage |
|---|---|---|
| Component | of raw material | (parts) |
| Vinyl-terminated | The viscosity was 100 mPa · s | 100 |
| silicone oil | | |
| Branched hydrogen- | The viscosity was 550 mPa · s (25° C.), | 15 |
| containing silicone | the hydrogen content was 0.015 wt % | |
| oil | | |
| Modified thermally | Modified alumina, with a modifier composed of | 1500 |
| conductive powder | dodecyltrimethoxysilane and vinyltriethoxysilane | |
| | in a mass ratio of 3:1. The total amount of | |
| | modifier used was 0.5% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Comparative Embodiment 1

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s | 100 |
| silicone oil | | |
| Hydrogen- | The hydrogen content was 0.15 wt % | 15 |
| terminated silicone | | |
| oil | | |
| Modified thermally | Modified alumina, with a modifier composed of | 1500 |
| conductive powder | dodecyltrimethoxysilane and vinyltriethoxysilane | |
| | in a mass ratio of 6:1. The total amount of | |
| | modifier used was 0.5% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, hydrogen-terminated silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Comparative Embodiment 2

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s. | 100 |
| silicone oil | | |
| Side-chain | The hydrogen content was 0.02 wt %, | 15 |
| hydrogen- | and the viscosity was 550 mPa · s | |
| containing silicone | | |
| oil | | |
| Modified thermally | Modified alumina, with a modifier composed of | 1500 |
| conductive powder | dodecyltrimethoxysilane and vinyltriethoxysilane | |
| | in a mass ratio of 6:1. The total amount of | |
| | modifier used was 0.5% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, side-chain hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Comparative Embodiment 3

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s. | 100 |
| silicone oil | | |
| Branched hydrogen- | The viscosity was 550 mPa · s (25° C.), | 15 |
| containing silicone | and the hydrogen content was 0.015 wt % | |
| oil | | |
| Modified thermally | Modified alumina, the modifier was dodecyl | 1500 |
| conductive powder | trimethoxysilane. The total amount of | |
| | modifier used was 0.5% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Comparative Embodiment 4

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s. | 100 |
| silicone oil | | |
| Branched hydrogen- | The viscosity was 550 mPa · s (25° C.), | 15 |
| containing silicone | and the hydrogen content was 0.015 wt % | |
| oil | | |
| Modified thermally | Modified alumina, the modifier was | 1500 |
| conductive powder | vinyltriethoxysilane. The total amount of | |
| | modifier used was 0.5% of the mass of | |
| | alumina powder | |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly. Then, adding the modified thermal conductive powder in three batches and stirring for 30 min until the mixture was uniform;
(2) putting the catalyst into the planetary mixer, stirring for 20 min, mixing evenly, and pumping vacuum to remove bubbles;
(3) after subpackaging, heating at 60° C. for 2 h to obtain a pre-cured single-component thermal conductive gel.

### Comparative Embodiment 5

This embodiment provided a pre-cured single-component thermal conductive gel, with raw material composition as follows:

| | Name or related parameters | Dosage |
|---|---|---|
| Component | of raw material | (parts) |
| Vinyl-terminated | The viscosity was 100 mPa · s. | 100 |
| silicone oil | | |
| Branched hydrogen- | The viscosity was 550 mPa · s | 15 |
| containing silicone oil | (25° C.), and the hydrogen | |
| | content was 0.015 wt % | |
| Thermally conductive | Alumina | 1492.54 |
| powder | | |
| Long-chain alkyl silane | Dodecyltrimethoxysilane | 6.39 |
| Vinyl silane | vinyltriethoxysilane | 1.07 |
| Inhibitor | 1-ethynyl-1-cyclohexanol | 0.2 |
| Catalyst | Castell catalyst | 5 ppm |

The specific preparation method included the following steps:
(1) putting the vinyl-terminated silicone oil, branched hydrogen-containing silicone oil, and inhibitor into a planetary mixer, stirring for 5 min and mixing evenly, and then adding the modified thermal conductive powder in 3 batches, followed by stirring for 30 min until the mixture is evenly mixed;
(2) putting the catalyst into the planetary mixer, stirring for 20 min and mixing evenly, and removing bubbles by vacuuming;
(3) after subpackaging, heating for 2 h at 60° C. to obtain the pre-cured single-component thermal conductive gel.

The single-component of thermal conductive gel composition prepared by the above embodiments and comparative embodiments were tested as follows:
1. Thermal conductivity: measured according to ASTM D 5470-01 Characterization Test for Thermal Conductivity Properties of Thin Thermal Conductive Solid State Electrical Insulation Materials;
2. Extrusion rate measurement method: rubber material was filled in a 30 cc syringe, the air pressure was set to 0.6 MPa, and the extrusion amount (mass) for 1 minute was recorded;
3. Determination of oil leakage: 10 g of single-component thermal conductive gel was placed on filter paper, and smeared into a round rubber sample with a diameter of 3 cm. After baking at 120° C. for 7 days, calculating the oil leakage area (the maximum area of the oil leakage edge−the area of the round rubber sample).

The test results were shown in the following table:

| | Thermal | Extrusion | Area |
|---|---|---|---|
| | conductivity | rate | of oil |
| | (W/mK) | (g/min) | leakage(cm²) |
| Embodiment 1 | 3.51 | 31.0 | 2.67 |
| Embodiment 2 | 3.46 | 33.6 | 2.56 |
| Embodiment 3 | 3.43 | 35.5 | 2.19 |
| Embodiment 4 | 3.47 | 34.7 | 2.87 |
| Embodiment 5 | 3.46 | 32.1 | 2.13 |
| Comparative | 3.47 | 35.8 | 8.96 |
| embodiment1 | | | |
| Comparative | 3.45 | 12.3 | 3.56 |
| embodiment 2 | | | |
| Comparative | 3.45 | 38.7 | 5.13 |
| embodiment 3 | | | |
| Comparative | 3.46 | 23.9 | 2.33 |
| embodiment 4 | | | |
| Comparative | 3.41 | 20.1 | 4.87 |
| embodiment 5 | | | |

According to the results in the table above, due to the same amount of thermal conductive powder in Embodiment 1 to 5, the thermal conductivity of all thermal conductive gel was around 3.5 W/mK, with an extrusion rate of over 30 g/min, and an oil leakage area of less than 3 cm², i.e. higher extrusion rate and lower oil bleeding rate. The difference between the Comparative embodiment 1 and the Embodiment 2 is that the Hydrogen-terminated silicone oil was used as the crosslinking agent. Although the extrusion rate of the thermal gel prepared by the Comparative embodiment 1 had certain advantages, the oil seepage area was up to 8.96 cm², showing the oil seepage was serious; for Comparative embodiment 2, the side-chain hydrogen-containing silicone oil was used as the crosslinking agent, the extrusion rate of the thermal conductive gel was only 12.3 g/min, and the oil seepage area was larger than that of Embodiment 1 to 5; for the thermal conductive filler in Comparative embodiment 3, only the long-chain alkyl silane was used for modification, without the vinyl silane being used for composite modification, the oil seepage area of the thermal conductive gel obtained was also more than 5 cm²; for the thermal conductive filler in Comparative embodiment 4, only vinyl silanes was used for modification. Although the oil leakage area of the thermal conductive gel was not different from that of other embodiments, its extrudability was general; for the Comparative embodiment 5, only long-chain alkyl silane and vinyl silane were added to the composition, without modification of the thermal conductive powder in advance. The extrudability of the thermal conductive gel obtained was worse than those in the embodiments, and the oil bleeding rate was also higher than those in the embodiments.

The technical features of the embodiments above can be combined arbitrarily. To simplify the description, all possible combinations of the technical features of the embodiments above are not described. However, as long as there is no contradiction in the combination of these technical features, they should be considered to be within the scope of the specification.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

What is claimed is:

1. A pre-cured single-component thermal conductive gel, being prepared from the following components in parts by weight and a platinum catalyst:

| | | |
|---|---|---|
| vinyl-terminated silicone oil | 100 | parts |
| branched hydrogen-containing silicone oil | 5 to 30 | parts |
| modified thermal conductive powder | 500 to 2500 | parts |
| inhibitor | 0.01 to 0.3 | parts; |

wherein a content of the platinum catalyst is 2 ppm to 10 ppm based on a mass of platinum;
wherein a structure of the branched hydrogen-containing silicone oil is: 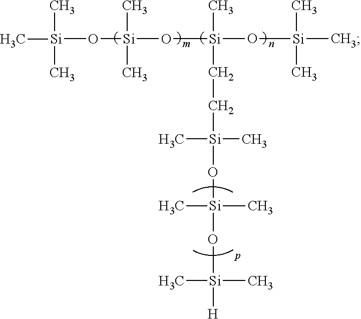
wherein a viscosity of the branched hydrogen-containing silicone oil is 200 mPa·s to 1000 mPa·s, and a hydrogen content of the branched hydrogen-containing silicone oil is 0.008 wt % to 0.15 wt %;
wherein the modified thermal conductive powder is prepared by modifying thermal conductive powder with a modifier; and
wherein the modifier consists of long-chain alkyl silane and vinyl silane.

2. The pre-cured single-component thermal conductive gel according to claim 1, being prepared from the following components in parts by weight and a platinum catalyst:

| | | |
|---|---|---|
| vinyl-terminated silicone oil | 100 | parts |
| branched hydrogen-containing silicone oil | 10 to 20 | parts |
| modified thermal conductive powder | 1000 to 2000 | parts |
| inhibitor | 0.01 to 0.3 | parts; |

wherein the content of the platinum catalyst is 2 ppm to 10 ppm based on the mass of platinum.

3. The pre-cured single-component thermal conductive gel according to claim 1, wherein the branched hydrogen-containing silicone oil is prepared by a hydrosilylation reaction of a hydrogen-terminated silicone oil and a side-chain vinyl silicone oil under an action of the platinum catalyst, and the reaction equation is as follows:

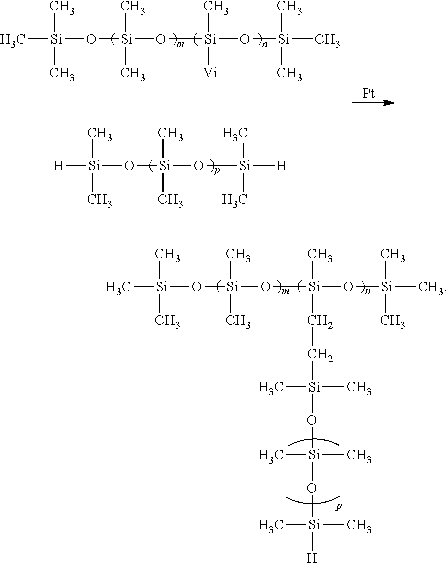

4. The pre-cured single-component thermal conductive gel according to claim 3, wherein a mass ratio of the hydrogen-terminated silicone oil and the side-chain vinyl silicone oil is 1:4 to 6; and/or,
a viscosity of the side-chain vinyl silicone oil is 100 mPa·s to 500 mPa·s, and a vinyl content of the side-chain vinyl silicone oil is 0.3 wt % to 1.0 wt %; a hydrogen content of the hydrogen-terminated silicone oil is 0.05 wt % to 0.2 wt %.

5. The pre-cured single-component thermal conductive gel according to claim 4, wherein the mass ratio of the hydrogen-terminated silicone oil and side-chain the vinyl silicone oil is 1:4.5 to 5.5; and/or,
the viscosity of the side-chain vinyl silicone oil is 150 mPa·s to 250 mPa·s, and the vinyl content of the side-chain vinyl silicone oil is 0.4 wt % to 0.6 wt %; the hydrogen content of the hydrogen-terminated silicone oil is 0.08 wt % to 0.12 wt %.

6. The pre-cured single-component thermal conductive gel according to claim 3, wherein the preparation method of the branched hydrogen-containing silicone oil comprises the following steps:
adding the side-chain vinyl silicone oil, the platinum catalyst, and a solvent into a reaction bottle, stirring evenly, and then dripping the hydrogen-terminated silicone oil, followed by heating up to 70° C. to 90° C. and reacting for 0.5 h to 2 h to obtain the product.

7. The pre-cured single-component thermal conductive gel according to claim 1, wherein the viscosity of the branched hydrogen-containing silicone oil is 500 mPa·s to 600 mPa·s, and the hydrogen content of the branched hydrogen-containing silicone oil is 0.01 wt % to 0.02 wt %.

8. The pre-cured single-component thermal conductive gel according to claim 1, wherein the long-chain alkyl silane is selected from at least one of C₈ to C₁₆ alkyl trimethoxysilane; and/or, the vinyl silane is vinyltrimethoxysilane and/or vinyltriethoxysilane; and/or,
the thermal conductive powder is selected from one or a combination of aluminum oxide, zinc oxide, magnesium oxide, aluminum nitride, and boron nitride.

9. The pre-cured single-component thermal conductive gel according to claim 1, wherein the modifier is composed of the long-chain alkyl silane and the vinyl silane in a mass ratio of 12 to 1:1; and/or,
a mass ratio of the thermal conductive powder to the modifier is 100:0.2 to 1.5.

10. The pre-cured single-component thermal conductive gel according to claim 9, wherein the modifier is composed of the long-chain alkyl silane and the vinyl silane in the mass ratio of 9 to 3:1; and/or,
the mass ratio of the thermal conductive powder to the modifier is 100:0.3 to 1.2.

11. The pre-cured single-component thermal conductive gel according to claim 1, wherein the preparation method of the modified thermal conductive powder includes the following steps: putting the thermal conductive powder into a reactor, spraying the modifier into the reactor after atomization under stirring, raising temperature to 60° C. to 80° C. to react for 2 h to 3 h to obtain the modified thermal conductive powder.

12. The pre-cured single-component thermal conductive gel according to claim 1, wherein a viscosity of the vinyl-terminated silicone oil is 50 mPa·s to 2000 mPa·s.

13. The pre-cured single-component thermal conductive gel according to claim 12, wherein the viscosity of the vinyl-terminated silicone oil is 100 mPa·s to 200 mPa·s.

14. The pre-cured single-component thermal conductive gel according to claim 1, wherein the platinum catalyst is selected from one or a combination of chloroplatinic acid, chloroplatinic acid isopropanol complex and Custer catalyst; and/or,
the inhibitor is selected from one or a combination of 1-ethynyl-1-cyclohexanol, tetramethyltetravinylcyclotetrasiloxane, 2-methyl-3-butyn-2-ol, 3-methyl-1-hexyn-3-ol, 3,5-dimethyl-1-hexyn-3-ol, and 3-methyl-1-dodecyn-3-ol.

15. A method for preparation of the thermal conductive gel according to claim 1, comprising the following steps:
(1) putting the vinyl-terminated silicone oil, the branched hydrogen-containing silicone oil, and the inhibitor into a planetary mixer, stirring and mixing evenly, and then adding the modified thermal conductive powder in batches, followed by stirring until the mixture is evenly mixed;
(2) putting the catalyst into a planetary mixer, stirring and mixing evenly, and removing bubbles by vacuuming;
(3) heating and pre-curing the mixture obtained in step (2) to obtain the pre-cured single-component thermal conductive gel.
